(19) United States
(12) Patent Application Publication
(10) Pub. No.: US 2026/0091416 A1
(43) Pub. Date: Apr. 2, 2026

(54) LIGHT-BASED SURFACE TREATMENT DEVICES AND METHODS

(71) Applicant: Vanalay US Inc, Sarasota, FL (US)

(72) Inventor: Andrew Barrows, Bradenton, FL (US)

(21) Appl. No.: 19/345,661

(22) Filed: Sep. 30, 2025

Related U.S. Application Data
(60) Provisional application No. 63/702,520, filed on Oct. 2, 2024.

(51) Int. Cl. B08B 7/00; B23K 26/352

(52) U.S. Cl. CPC B08B 7/0042; B08B 7/0014; B23K 26/352

(57) ABSTRACT

A method for treating a non-biological surface. A sorbent layer may be applied to a non-biological surface prior to treating the non-biological surface with a light-based energy source. The sorbent layer may protect the non-biological surface, prevent any produced plume from escaping into the atmosphere, maintain the non-biological surface at a cooler temperature, and remove material from the non-biological surface.

### CROSS-REFERENCE TO RELATED APPLICATIONS

This application claims benefit of U.S. Provisional Application No. 63/702,520, filed Oct. 2, 2024, the entire disclosures of which are incorporated herein by reference.

### TECHNICAL FIELD

The present disclosure is directed to devices and method for light-based surface treatment, including use of a sorbent, such as a hydrogel, to assist in removing contaminants from surfaces.

### BACKGROUND

Surface treatments may use energy-based devices, such as for example, lasers, light sources, ultrasounds, or other devices to direct an energy source to a surface. Surface treatments may be processes applied to the surface of materials to, for example, alter their properties, enhance performance, protect against environmental factors, etc. Laser surface treatments may refer to techniques to utilize laser energy to modify the surface properties of materials. Examples of laser surface treatments include laser ablation, laser texturing, laser shock peening, laser cleaning, laser marking and engraving, etc. For example, laser cleaning may be used to remove oxidants, oxides, and other unwanted materials from the surface. Unwanted materials may include old paint, lead paint, rust, mold, blood spills, etc. Such use of energy-based devices in industrial and medical applications may involve the risk of generating airborne particles, which can be hazardous to health and the environment. For example, traditional laser treatments can produce smoke and residue, leading to potential contamination and safety concerns. There is a need for solutions that can mitigate these risks while maintaining the effectiveness of such treatments.

### SUMMARY

To solve the problems of existing surface treatment devices and methods, the present disclosure provides devices and methods for reducing airborne particles generated from surface treatment by energy-based devices.

A method of treating a non-biological surface may include applying a sorbent layer to the non-biological surface and directing, from a directed energy device, an energy source through at least a portion of the sorbent layer. When the energy source is absorbed by the non-biological surface, a plume may be produced, and the sorbent layer may absorb or adsorb the plume, which may be hazardous.

A method of treating a metal surface may include applying a sorbent layer to the metal surface and directing a laser beam having a wavelength of at least 1060 nm through at least a portion of the sorbent layer. In some examples, the metal has a removable material, deposit, or layer, such as a contaminant, debris, or spillage, that is desired to be removed. When the energy source is absorbed by the metal surface, plume may be produced and the contaminant may be separated from the metal surface, and the sorbent layer may absorb or adsorb at least a portion of the plume and at least a portion of the removable material, both of which may be hazardous. Removing the sorbent layer from the metal surface may remove at least a portion of the removal material and/or at least a portion of the contents of the plume.

A system for treating a metal surface may include a metal surface comprising a contaminant and a sorbent layer applied to the metal surface.

A device for treating a non-biological surface may include a sorbent layer for treating the non-biological surface, where the sorbent layer is applied to the non-biological surface.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure can be understood in consideration of the following detailed description of various embodiments in connection with the accompanying drawings.

FIG. 1 is a photograph illustrating an example sorbent layer to assist in absorbing or adsorbing particulate matter.

FIG. 2 is a schematic diagram illustrating an example sorbent layer to assist in absorbing or adsorbing particulate matter.

FIG. 3 is a schematic diagram illustrating an example sorbent layer to assist in absorbing or adsorbing particulate matter.

FIGS. 4A and 4B are photographs illustrating using an example sorbent layer to assist in removing a material from a surface.

FIGS. 5A through 5D are photographs illustrating using an example sorbent layer to assist in absorbing or adsorbing particulate matter.

FIGS. 6A and 6B are schematic diagrams illustrating an example absorbent layer to assist in absorbing or adsorbing particulate matter.

FIGS. 7A, 7B, and 7C are photographs illustrating using an example sorbent layer to remove a material from a surface.

FIG. 8 is a photograph illustrating the use of a sorbent layer to remove a material from a surface.

FIG. 9 is a flow diagram illustrating an example method of using a sorbent layer to absorb or adsorb particulate matter.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure describes devices and methods for light-based treatment of non-biological surfaces, for example, in industrial applications of laser ablation (e.g., laser cleaning) that uses a sorbent layer, such as a hydrogel patch, to absorb or adsorb the plume generated from the light-based treatment while continuing to be effective in removing the material that is desired to be removed from the non-biological surface. The devices and methods may also reduce damage to the surface or the sorbent layer. The devices and methods may also maintain the surface at a cooler temperature to prevent overheating of the surface. The sorbent layer may also absorb or adsorb the material that is desired to be removed from the non-biological surface. The removal of the sorbent layer from the non-biological surface may remove the material that is desired to be removed from the non-biological surface as well as the contents (e.g., particulate matter) of the plume. The issues with industrial applications of laser cleaning may include, for example, the plume produced by laser cleaning. Plume can contain carcinogens and toxins. The use of a sorbent layer may be a protective measure against the inhalation of these carcinogens or toxins by capturing the plume or preventing the release of the plume.

A non-biological surface may refer to any surface that is not a surface of an organism. A non-biological surface may include a surface that is derived from an organism or biological sources, such as a biomaterial, for example, a natural polymer, a bioceramic, a biocompatible metal, biodegradable polymer, natural extract or compound, etc. A non-biological surface may be made from an engineered material (e.g., intentionally designed, synthesized, modified for specific purposes or applications, etc.). A non-biological surface may be made from a functional material, which may refer to materials that are designed, engineered, or modified to exhibit specific properties or functions for targeted application. Functional materials encompass a broad range of materials, including biomaterials and inorganic materials, regardless of whether they are derived from natural sources or synthesized through engineering processes. A non-biological surface may refer to an inorganic surface. Examples of inorganic surfaces may include metals, ceramics, metals, synthetic polymers, etc. A non-biological surface may encompass surfaces that are purely physical or chemical in nature. Examples of non-biological surfaces, include metal surfaces, such as steel, stainless steel, anodized aluminum, etc. These materials may have different characteristics, including hard, soft, rigid, flexible, etc.

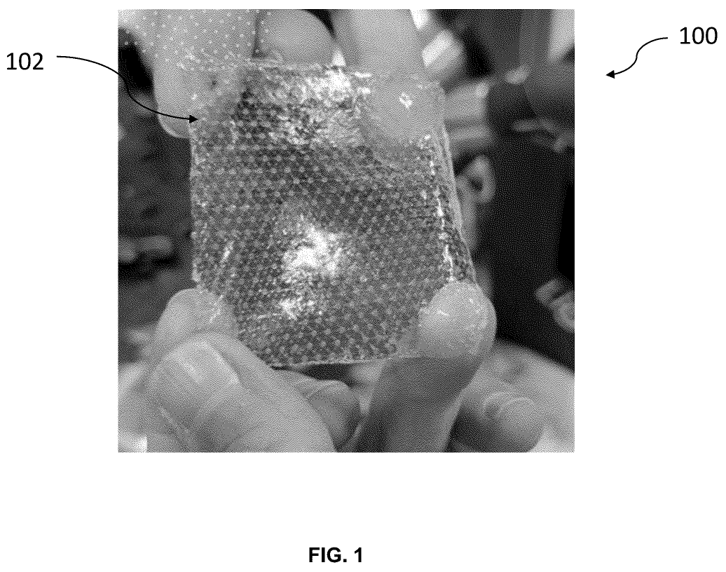

FIG. 1 is a photograph 100 illustrating an example sorbent patch 102, such as a hydrogel patch, to assist in absorbing particulate matter. Sorbent patch 102 may include a sorbent (e.g., hydrogel) or sorbent layer (e.g., hydrogel layer). A sorbent patch may perform an uptake action of taking up or incorporating a material without the sorbent patch's material structure (e.g., absorb) or on its surface (e.g., adsorb). The uptake action may include absorption and adsorption. The sorbent patch may be an uptake patch that has the capabilities of being an absorbent patch or adsorbent patch. Absorbent may refer to materials capable of absorbing substances (e.g., liquids, gases, solids, etc.) into their bulk structure through a process called absorption. Adsorbent may refer to materials capable of adsorption, which involves the adhesion of atoms, ions, or molecules from a gas, liquid, or dissolved solid onto the surface of the adsorbent material. The sorbent layer may have some adhesive or attachment properties that it might resists separation from the surface.

Hydrogel is a clear cross-linked polymer containing mostly water. Sorbent patch 102, such as a hydrogel patch, may block particles (e.g. mold, lead paint, etc.) from becoming airborne. The hydrogel may be used to absorb or adsorb plumes and/or material separated from a surface as well as aid in positioning the patch, delineating a work site on the surface, and/or adhesive characteristics. The hydrogel patch may absorb heat from a laser beam, reducing the delta temperature ΔT or the difference in temperature of the surface covered by a hydrogel patch when subjected to laser treatment and temperature of the surface that is not covered by a hydrogel path when subjected to laser treatment. The ΔT may be at least 5 degrees Celsius. In other words, a surface with a hydrogel patch subjected to laser treatment may be approximately 5 degrees Celsius cooler than a surface without a hydrogel patch subjected to the same laser treatment. The hydrogel cross-linked hydrophilic polymer may be highly absorbent or adsorbent of materials generated from laser ablating a surface and maintain its defined structure particularly when supported by the polymeric covering.

In some examples, sorbent patch 102 may be a hydrogel patch that is comprised of hydrogel encased within a polymeric covering. The polymeric covering may fully or partially encase the hydrogel. The polymer covering may also be transparent. In some examples, the sorbent patch is a sorbent layer of a sorbent, such as a hydrogel, without the polymeric cover. The sorbent patch may be formed from any number of layers (e.g., one, two, three, four), at least one of which includes a sorbent layer. In some examples, the sorbent patch (e.g., hydrogel patch) may be 50 wt %-99 wt % of water, such as 95 wt % of water. In some examples, the sorbent patch (e.g., hydrogel patch) may include a preservative, such as a paraben. Paraben may be used to maintain the transparency and effectiveness of the patch during laser treatments while preventing microbial growth due to the anti-microbial properties of paraben.

Sorbent patch 102, such as a hydrogel patch, may be transparent. Sorbent patch may allow transmission by an energy source (e.g., laser beam) from a directed energy device (e.g., laser). For example, sorbent patch 102 may allow the laser beams of varying wavelengths, such as in the near-infrared and infrared range, for example, at least 755 nm, at least 1060 nm, at least 1064 nm, at least 1070 nm, or at least 1100 nm, to transmit through the gel until reaching the surface. Sorbent patch 102 may allow 80%-99% transmission of the laser beam, such at least 80%, 85%, 90%, 95%, or 99% transmission. Sorbent patch 102 may be made of materials that have low absorbency for the particular laser wavelength being used to process the surface and capable of withstanding the particular laser wavelength employed in the process. Any types or sizes of a directed energy device may be used, for example, a hand-held laser with adjustable power settings, such as a commercial product IPG Photonics LightWELD XC Handheld Laser Welding and Cleaning System. The power of the directed energy device may be adjusted to different powers, such as 300 Watts, 1100 Watts, etc.

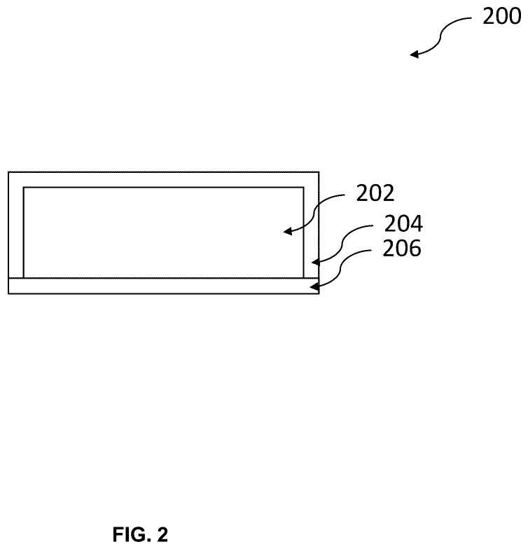

FIG. 2 is a schematic diagram illustrating an example sorbent patch 200, such as a hydrogel patch, to assist in absorbing or adsorbing plume or other materials desired to be removed from a surface. The sorbent patch 200 may be a hydrogel patch having sorbent layer 202, such as a hydrogel layer, covered by the polymeric layer 204 and which extends over the sides of the absorbent layer 202. The release liner 206 may be removed from the sorbent layer 200. The release liner 206 may facilitate application and prevent debris or other foreign matter from contact with the sorbent layer 200 prior to treatment.

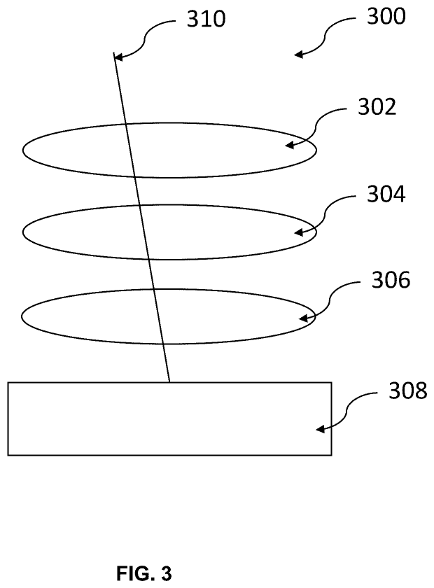

FIG. 3 is a schematic diagram illustrating an example sorbent patch 300, such as a hydrogel patch, to assist in absorbing or adsorbing particulate matter. The sorbent patch 300 may include a clear and transparent plastic or polymeric liner 302 and having an adhesive and sorbent layer 304 (e.g., hydrogel) beneath or on the bottom surface of liner 302. A release liner 306 may be provided for removal prior to the positioning of the sorbent layer 304 on the surface 308. An energy source 310, such as a laser beam, may be directed at the sorbent patch 300. Various shapes or configurations of the hydrogel patch may include circular (e.g., circle, oval, etc.) as shown in FIG. 3 and rectangular (e.g., rectangle, square, etc.) shapes as shown in FIG. 2. The various configurations may be provided having various dimensions depending upon the nature (e.g., size, shape, etc.) of the worksite on the surface. For example, the oval configuration may be approximately 2 inches in length. The square configuration may be 4 inches by 4 inches in size. The rectangular configuration may be 12 inches by 24 inches. The sorbent patch may have a variety of different textures, such as rough, smooth, soft, hard, bumpy, gritty, etc. In some examples, the sorbent patch may appear to have bubbles. In some examples, the sorbent patch, sorbent layer, polymeric covering, polymeric liner, or release liner may have a pattern of circles, smaller circles between larger circles, larger circles between smaller circles, lines connecting circles, lines connecting smaller circles with larger circles, etc. The pattern may be regular with repetition and symmetry.

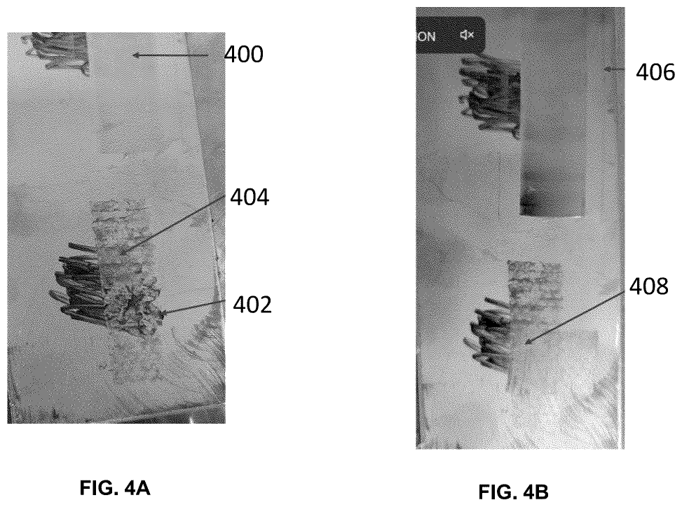

FIGS. 4A and 4B are photographs illustrating using an example sorbent patch to assist in removing a material from a surface. FIG. 4A shows the results of using a sorbent patch and varying the number of passes of an energy-based source, such as a laser beam, to see how well black permanent marker is removed from a non-biological surface, such as steel. The laser may be an IPG Photonics LightWELD XC Handheld Laser Welding and Cleaning System. The laser beam may have a wavelength of 1100 nm. Sorbent layers were not applied at portion 400 of the metal surface, such as steel surface, as shown in FIG. 4A and at portion 406 of the metal surface, such as steel surface, as shown in FIG. 4B; these portions 400, 406 of the metal surface represent the control portions. The control portions had a black permanent marker stain. Sorbent layers were applied to portions 402, 404, and 408 of the metal surface over a black permanent marker stain. Test portion 402 represent the test portion for one pass of the laser beam through the sorbent layer. Test portion 404 represents the test portion for two passes of the laser beam through the sorbent layer. Test portion 408 represents the test portion for three passes of the laser beam through the sorbent layer. Control portion 400 without the sorbent layer shows the black permanent marker stain removed. Test portion 402 with the sorbent layer and one pass of the laser beam through the sorbent layer shows some stain remaining on the metal surface. Test portion 404 with the sorbent layer and two passes of the laser beam through the sorbent layer shows more stain was removed from the metal surface as compared to test portion 202 with a single pass of the laser beam. Test portion 408 with the sorbent layer and three passes of the laser beam through the sorbent layer shows that most, if not all, of the stain was removed. Control portions 400, 406 show the most, if not all, of the stain was removed.

The power of the laser beam can be adjusted or increased. The laser beam power may be 200 Watts-1200 Watts, such as 300 Watts or 1100 Watts. With 3 passes of the laser beam at 1100 Watts at wavelengths, such as 1100 nm, through the sorbent layer, no damage to the sorbent layer (e.g., keep consistency, did not create a hole in the sorbent layer, divide the sorbent layer into pieces, etc.) or metal surface was observed. The sorbent layer may be durable to resist degradation, prolonging its usability or reusability. Multiple passes of the laser beam and/or laser beam at higher power and/or laser beam at higher wavelength may be more effective than lesser passes of the laser beam and/or laser beam at lesser power and/or laser beam at higher wavelength.

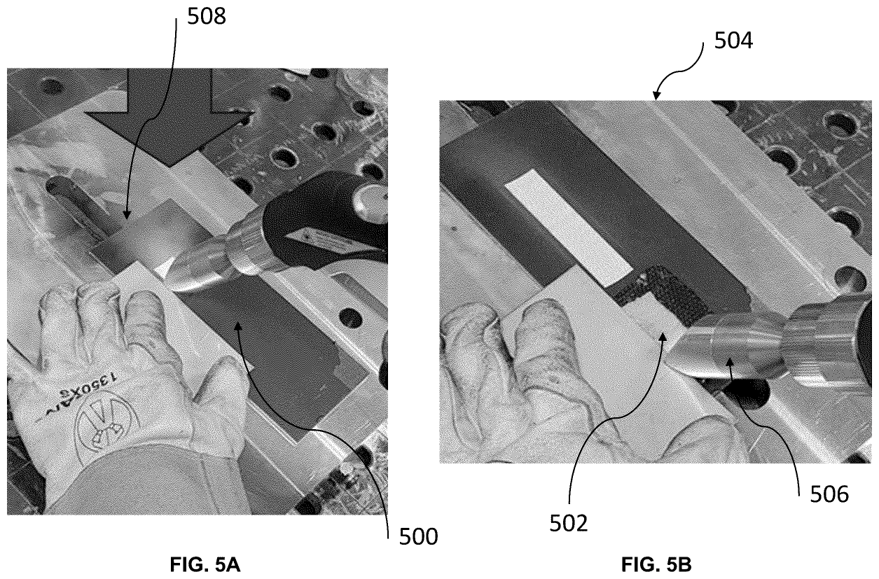

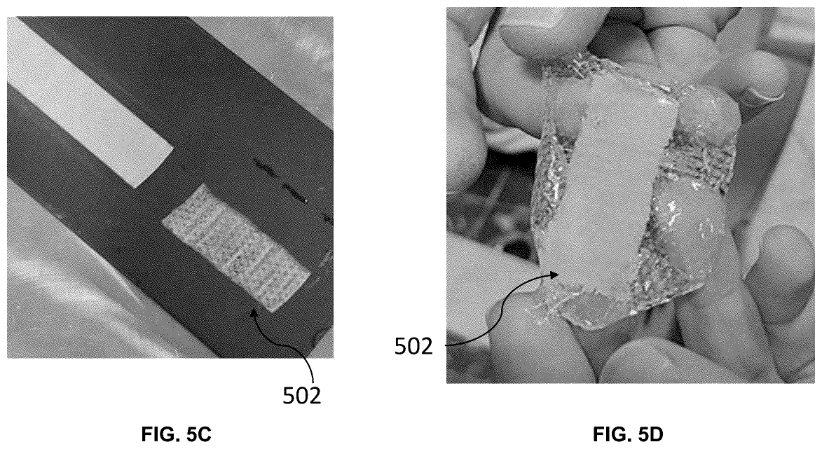

FIGS. 5A, 5B, 5C, and 5D are photographs illustrating using an example sorbent patch to assist in absorbing or adsorbing plume and/or material desired to be removed from a surface, such as anodized aluminum. FIG. 5A shows the results of subjecting a stained metal surface without a sorbent layer 500 to a single pass of a laser beam at 1100 nm from a laser 506. A plume or smoke 508 was visible. FIG. 5B shows the results of subjecting a stained metal surface with a sorbent layer 502 to a single pass of a laser beam at 1100 nm from a laser 506. Plume or smoke was not visible with the use of a sorbent layer 502 as compared to omitting the use of a sorbent layer in FIG. 5A. With one pass of the laser, it was observed that more stain remained on the metal surface when a sorbent layer was used as compared to when a sorbent layer was not used. However, the sorbent layer appeared to reduce or eliminate smoke as smoke was visible in FIG. 5A in which a sorbent layer was not used and smoke was not visible in FIG. 5B in which a sorbent layer was used. FIG. 5C shows the sorbent layer on the metal surface after being subjected to the laser beam. FIG. 5D shows the removal of the sorbent layer 502 from the metal surface after being subjected to laser. In FIG. 5D, the sorbent layer turned white from its original clear or transparent color, suggesting that the sorbent layer absorbed or adsorbed the plume, smoke, airborne particulate matter, etc.

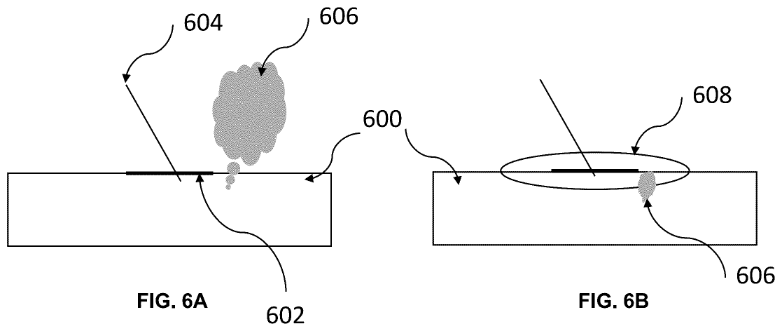

FIGS. 6A and 6B are schematic diagrams illustrating an example sorbent patch to assist in absorbing or adsorbing plume and/or material desired to be removed from a surface. FIG. 6A shows a procedure whereby laser beam 604 of desired power and wavelength is directed to a work site 602, which may be a material or layer (e.g., lead paint), on a metal surface 600. A gaseous plume 606 is shown being generated from the work site as the laser light beam 604 interacts with the metal surface 600. FIG. 6B shows the sorbent layer 608 covering the work site on the metal surface. The plume 606 is shown captured beneath the sorbent layer 608 as the laser beam 604 is directed through the sorbent layer 608.

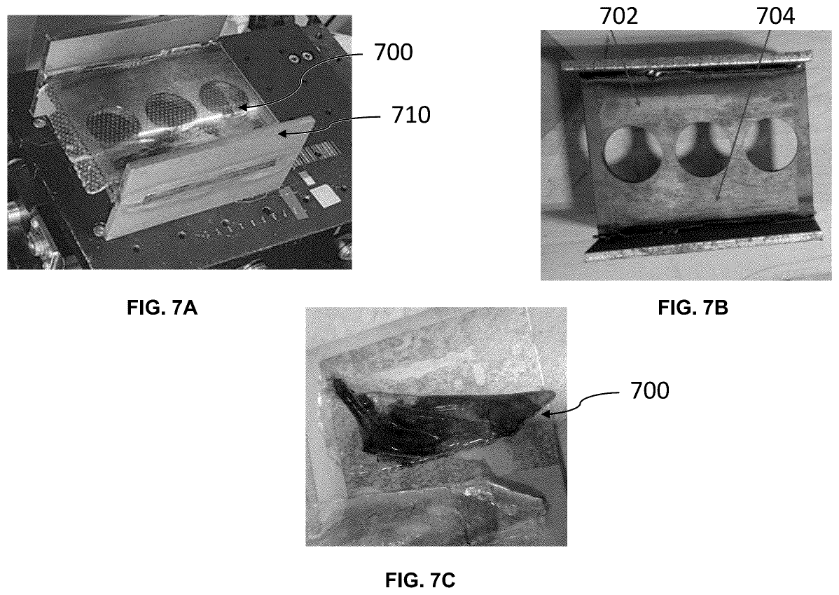

FIGS. 7A, 7B, and 7C are photographs illustrating using an example sorbent patch to remove a material from a surface. FIG. 7A shows sorbent layer 700 placed on a surface of a workpiece 710. A laser beam of 300 Watts was used. FIG. 7B shows the results after subjecting the workpiece 710 to a laser beam and removing the sorbent layer 700. The top portion 702 of the workpiece 710 was cleaner than the bottom portion 704 of the workpiece 710. FIG. 7C shows the dirty sorbent layer 700 after being removed from the workpiece 710 and after being subjected to a laser beam. The sorbent layer 700 appears to have absorbed or adsorbed the particles that would have been airborne during the laser process, and these particles may be the particles on the material or particles generated during the laser process.

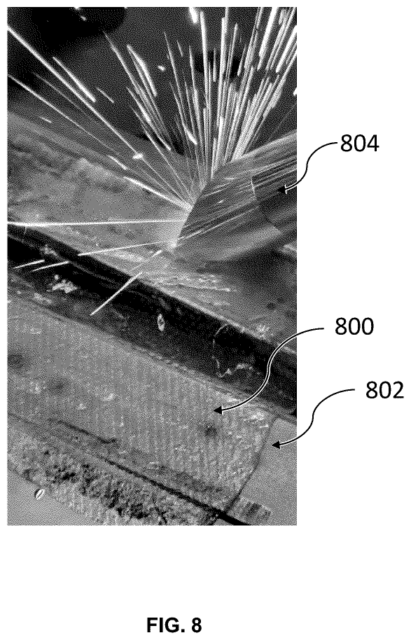

FIG. 8 is a photograph illustrating the use of a sorbent layer 800 to remove a material from a surface 802. Laser 804 was directed through the sorbent layer 800. Without the sorbent layer 800, the laser 804 made a deep etch into the steel surface 802. The sorbent layer 800 appeared to protect the steel surface 802 from damage, such as a deep etch.

In some examples, when a stained surface (e.g., stained with black ink) is covered with a sorbent layer and a laser beam was directed through the sorbent layer, the stain (e.g., black ink) is trapped between the gel and steel. Peeling off the sorbent layer caused the stain (e.g., black ink) to be removable, for example, by coming off with the peeled sorbent layer or being displaced from its original position so it can be easily removed without further laser processing. In some examples, there is an attraction between the stain and the sorbent layer so that the stain and sorbent layer are drawn together.

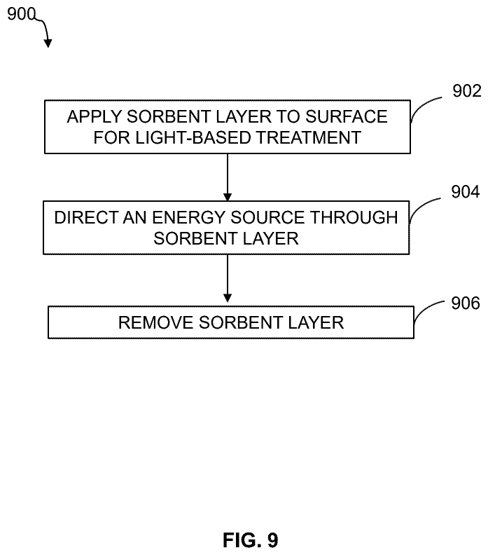

FIG. 9 is a flow diagram illustrating an example method 900 of using a sorbent layer to absorb or adsorb plume or removable material. Method 900 may include applying a sorbent layer to a surface with a removable material for light-based treatment. Applying a sorbent layer may include direct contact between the sorbent layer and the surface that is to be subjected to light-based treatment. The sorbent layer may exhibit properties of adhering or attaching to the surface, such that the sorbent layer may resist separation from the surface. In some examples, the sorbent layer does not adhere or attach to the surface but lies on the surface. The surface may support the sorbent layer with or without the sorbent layer adhering to the surface. Step 904 may include a step of directing an energy source, such as a laser beam, through the sorbent layer. The energy source may reach and interact the surface so the removable material is separated from the surface, and this process may produce a plume. The sorbent layer may contain the removable material and/or the plume to reduce airborne material in the air.

The energy source (e.g., laser beam) may be provided from a directed energy device (e.g., laser) at different wavelengths, different powers, etc. The energy source may be directed through the sorbent layer any number of times (e.g., one, two, three, four, etc.) in a discrete or continuous manner (e.g., discrete passes as in pulsed lasers, continuous laser passes). Discrete Laser Passes may refer to laser passes that are distinct and separate from each other, such as laser emitting light in short bursts or pulses. Continuous laser passes may refer to laser passes that are continuous and uninterrupted, for example the laser emits a constant, unbroken beam of light.

Step 906 may include removing the sorbent layer, which may cause the removal of the removable material from the surface as well as the contents of the plume that would have been released in the air if it were not the use of the sorbent layer.

The sorbent layer may be used in a variety of applications, including removing lead paint, mold, blood, etc. on different non-biological surfaces that may be in different technologies, such as microchips, aviation, etc.

What is claimed is:

1. A method of treating a non-biological surface, comprising:
applying a sorbent layer to the non-biological surface; and
directing, from a directed energy device, an energy source through at least a portion of the sorbent layer, whereby absorption of the energy source by the non-biological surface produces a plume, the plume being absorbed or adsorbed by the sorbent layer.

2. The method of claim 1, wherein the sorbent layer is transparent and adjacent to a transparent polymeric covering.

3. The method of claim 1, wherein the sorbent layer is a hydrogel patch.

4. The method of claim 1, wherein the sorbent layer comprises 95% by weight of water and a paraben.

5. The method of claim 1, wherein the directed energy device comprises a laser, and the energy source is a laser beam.

6. The method of claim 1, wherein the directed energy device emits light with a total power output of at least 300 watts or at least 1000 watts.

7. The method of claim 1, wherein the sorbent layer has at least 95% transmission when exposed to the energy source with a wavelength of at least 755 nm, at least 1060 nm, at least 1064 nm, at least 1070 nm, or at least 1100 nm.

8. The method of claim 1, wherein the non-biological surface comprises debris or spillage that is absorbed or adsorbed by the sorbent layer.

9. The method of claim 1, wherein the plume comprises particulate matter.

10. The method of claim 1, wherein the plume comprises an aerosol or a droplet.

11. The method of claim 1, wherein the plume is smoke.

12. The method of claim 1, wherein the method of treating the non-biological surface is a method of laser cleaning the non-biological surface.

13. The method of claim 1, wherein the method of treating the non-biological surface comprises removing lead paint or mold from the non-biological surface.

14. The method of claim 1, wherein the method of treating the non-biological surface comprises cleaning a blood spill from the non-biological surface.

15. The method of claim 1, wherein the non-biological surface is at least 5 degrees Celsius cooler with the absorbent layer applied to the non-biological surface than without the absorbent layer applied to the non-biological surface.

16. The method of claim 1, wherein the non-biological surface is a metal surface.

17. The method of claim 1, wherein the non-biological surface is made of steel or anodized aluminum.

18. The method of claim 1, wherein the directed energy devices is directed through at least the portion of the absorbent layer at least three times.

19. A method of treating a metal surface, comprising:
applying a sorbent layer to the metal surface, the metal surface comprising a removal material;
directing a laser beam having a wavelength of at least 1060 nm through at least a portion of the sorbent layer, whereby absorption of the energy source by the metal surface produces a plume and separates the removal material from the metal surface, at least a portion of the plume and at least a portion of the removable material being absorbed or adsorbed by the absorbent layer, and
removing the sorbent layer to remove the removable material from the metal surface.

20. The method of claim 19, wherein the removable material is a contaminant.
